(19) United States
(12) Patent Application Publication
(10) Pub. No.: US 2024/0042749 A1
(43) Pub. Date: Feb. 8, 2024

(54) PARTITION FOR A COMMERCIAL OR TRANSPORT VEHICLE

(71) Applicant: Volkswagen Aktiengesellschaft, Wolfsburg (DE)

(72) Inventors: Carsten JATZEN, Braunschweig (DE); Kevin ROOK, Hameln (DE); Fabian FISCHER, Hannover (DE); Thomas Grosse, Braunschweig (DE); Daniel KOHL, Sontra (DE); Falk-Andreas HOEFER, Hademstorf (DE)

(73) Assignee: Volkswagen Aktiengesellschaft, Wolfsburg (DE)

(21) Appl. No.: 18/230,229

(22) Filed: Aug. 4, 2023

(30) Foreign Application Priority Data
Aug. 5, 2022 (DE) 10 2022 208 183.8

(51) Int. Cl. B32B 37/18; B32B 21/14; B32B 5/02; B32B 21/04; B32B 21/10; B32B 21/02; B27N 3/02; B27N 3/06; B62D 33/04; B62D 33/06

(52) U.S. Cl. CPC B32B 37/18; B32B 21/14; B32B 5/02; B32B 21/042; B32B 21/10; B32B 21/02; B27N 3/02; B27N 3/06; B62D 33/04; B62D 33/06; B32B 2260/026; B32B 2260/046; B32B 2307/584; B32B 2307/714; B32B 2307/7246; B32B 2307/304; B32B 2307/102; B32B 2605/003; B32B 2305/18; B32B 2317/16; B32B 2305/07

(57) ABSTRACT

A method for producing a partition for the interior of a commercial or transport vehicle for separating a passenger compartment from a cargo compartment. The partition is designed as a multilayer composite component made of a renewable raw material, in particular a wood-based material, which is produced by a forming process in a forming die.

This nonprovisional application claims priority under 35 U.S.C. § 119(a) to German Patent Application No. 10 2022 208 183.8, which was filed in Germany on Aug. 5, 2022, and which is herein incorporated by reference.

### BACKGROUND OF THE INVENTION

### Field of the Invention

The present invention relates to a method for producing a partition for the interior of a commercial or transport vehicle and to such a partition.

### Description of the Background Art

Commercial vehicles, which are used for parcel delivery, for example, transport parcels of different dimensions. For driver protection, a partition is provided for such delivery vehicles, which separates the cargo compartment from the passenger compartment. In the event of rapid vehicle deceleration, such as a frontal collision, the partition prevents parcels from being shifted forward into the passenger compartment.

A partition of the same type can be made of a deep-drawn sheet steel part, of plastics (PE, PP, . . . ), or of fiber composite plastics, which are reinforced by short or long fibers and can, for example, have glass fibers or the like.

The materials currently used in the manufacture of a partition all have a large CO₂ footprint and a comparatively high density with a correspondingly high component weight. In addition, optical, acoustic, thermal and/or mechanical additional functions can often only be implemented through significant changes in the production process and/or through additional process steps that are complex in terms of manufacturing technology.

US 2021/0300161 A1 discloses a vehicle door with a support structure made of a recyclable environmentally friendly natural fiber. CN 111572647 A as well as DE 10 2018 120 190 A1 disclose vehicle components, which are made from a renewable raw material.

### SUMMARY OF THE INVENTION

It is therefore an object of the present invention to provide a partition as well as a method for producing such a partition, which can be produced in lightweight construction as well as with a reduced overall CO₂ balance compared to the state of the art.

The invention is based on a method for producing a partition for the interior of a commercial or transport vehicle by means of which a passenger compartment can be separated from a cargo compartment. The partition can be designed as a multilayer composite component made of a renewable raw material, particularly of a wood-based material. The multilayer composite component can be produced by a forming process in a forming die under pressure and heat.

Through the use of wood-based materials in the form of laminated veneer lumber, strand-based (wood chip-based) semi-finished wood products, or a mixture of these two, as well as other renewable raw materials, the partition is produced according to the invention by a forming process in the forming die. During the forming process, the renewable raw materials, particularly wood-based materials, are modified if necessary (compacted, compressed, soaked with resin/adhesive, . . . ) and shaped as required with temperature and a suitable adhesive system (PU adhesive, epoxy adhesive, . . . ).

When using laminated veneer lumber, the property of the component can be specifically influenced by the arrangement and orientation of the veneers. This produces the necessary geometric stiffening elements in the component. It can be done both over a wide area and locally. In particular, it is possible to eliminate visually unappealing reinforcing beads, which were necessary in components made of plastic or steel, or to make them more visually appealing.

By constructing or combining the wood-based elements with each other and with additional materials/layers, various additional functions can be fulfilled. On the one hand, top layers made of impregnated/soaked wood can produce both visual (design/décor) and functional (scratch, moisture and/or chemical resistant) properties. Moreover, wood veneers can be used as cover surfaces to create visually appealing surfaces.

Furthermore, it is possible to produce thermal and/or acoustic insulation effects by building and/or introducing additional materials/layers in the composite. Local stiffening in the components can be achieved by partial compression or local thickening of the material.

After the forming process, the partition can be mechanically processed in a further process step and then given its final component contour. Cutouts or clearances can be inserted during this step if necessary.

The use of wood-based materials according to the invention in the form of laminated veneer lumber, strand-based (wood chip-based) semi-finished wood products, or a mixture of these two, as well as other renewable raw materials in a partition of a commercial and/or transport vehicle, is carried out while maintaining the mechanical requirements. In this context, the good mechanical properties of laminated veneer lumber, strand-based (wood chip-based) semi-finished wood products, or a mixture of these two and other renewable raw materials are of great importance. In addition, all composite structure and process-oriented aspects can be implemented in a central manufacturing process, so that the basic material/semi-finished product can be produced completely in a one-shot process.

In addition, the approach offers a systemic and highly flexible solution from a joining point of view, as screw-on and/or fastening points (e.g., metallic elements such as eyelets or hooks) can be placed freely and individually. This flexibility also applies to the actual installation of the partition in the vehicle structure. Metal eyelets can be used, for example, around the screw points to prevent the screws from tearing out of the partition and screw removers due to setting behavior. Furthermore, extensions can be attached to the partition at any point by means of a direct screw connection (by screwing into the wood). These screw locations can also be locally strengthened by partial compression or partial thickening of the material.

The one-piece or multi-part partition can be made from a renewable raw material as a laminated wood composite. Due to the multi-part structure, different model derivatives as well as special functions (through-loading feature, window patching, storage capacity, lashing devices, . . . ) can be realized. For this purpose, veneers of the appropriate size are glued, stacked and inserted into the forming die as a “stack.” The forming die was heated to a temperature (up to 150° C.) according to the requirements of the adhesive, so that the crosslinking of the adhesive can take place taking into account the cycle time. At the same time, the veneer stack is pressed, three-dimensionally formed and designed according to the requirements of the component in terms of rigidity, strength, and crash, as well as the ability to be mounted on the body of the vehicle.

The additional functions can be easily implemented by introducing additional layers/materials in the “stack.” For example, a film on the surface can take on the task of being moisture-repellent, chemical-resistant and/or scratch-resistant. Foam cores inside the layer composite can improve acoustics and/or thermal insulation. Additional components such as through-loading boxes can also be made of the same material in the process described above and connected to the partition (by screwing, snapping, etc.).

Subsequently, essential aspects of the invention are again highlighted in detail. For example, the multilayer composite component can be made of wood veneer layers and/or chips or strands made of renewable raw materials. Strands refers to large-scale chips, such as wood chips or shavings made from other renewable raw materials with optimized chip geometry (length-width-thickness ratio). For example, the wood veneer layers can be sheets of solid wood about 0.5 to 8 mm thick, which are separated from the log by various sawing and cutting methods.

In a preparatory process step, a binder can be applied to the chips and/or the wood veneer layers. In a downstream forming process step, the wood veneer layers and/or the chips are inserted into a mold cavity of the forming die. Subsequently, the forming process starts, in which the wood veneer layers and/or the chips are compressed and glued under pressure and heat to form the partition.

In a technical implementation, the binder-coated chips can be loosely inserted into the mold cavity of the forming die as bulk material, whereupon the forming process step starts. Alternatively, the binder-coated chips can be subjected to an upstream pressing step before the forming process step is performed. In this pressing step, the chips can be pressed into a flat semi-finished product. The flat semi-finished product can then be inserted into the mold cavity of the forming die for performing the forming process.

The component rigidity of the partition can preferably be increased in a simple manner as follows: For example, the partition can be made of wood veneer layers whose fiber orientations are aligned differently with each other. This results in a multilayer composite component with multidirectional fiber orientation, which is advantageous in terms of stiffness requirements. Alternatively, in the production of a chip-based partition, the chips can be arranged unoriented in a random position in relation to each other in the multilayer composite component.

The partition can be equipped with additional optical, acoustic, thermal and/or mechanical functions in a simple manner from a manufacturing point of view. For this purpose, at least one additional insert part can be inserted into the mold cavity of the forming die together with the wood veneer layers and/or the chips. The insert part is adapted to fulfill the desired additional function. By way of example, the additional insert part can form a top layer that is resistant to scratches/moisture/chemicals and/or that fulfills a decorative function. By way of example, the additional insert part can be a wood veneer layer impregnated with a plastic. Alternatively, and/or additionally, the insert part may have a thermal and/or acoustic insulating effect. In this case, the insert part can be a fabric, a non-crimp fabric, or a fleece, for example.

In addition, the partition according to the invention can be equipped with local stiffeners in a simple manner in terms of manufacturing. For this purpose, a partition reinforcement section can be formed by local compression. In local compression, the partition reinforcement section is locally compressed in the forming process due to increased forming pressure as compared to other partition sections.

Alternatively, such a partition reinforcement section can also be provided by local thickening. In the case of such local thickening, the partition reinforcement section can be formed with increased material input, i.e., with at least one additional layer of wood veneer and/or with additional chips, as compared to other partition sections.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 7 show different views in each case, which illustrate the production of a partition.

### DETAILED DESCRIPTION

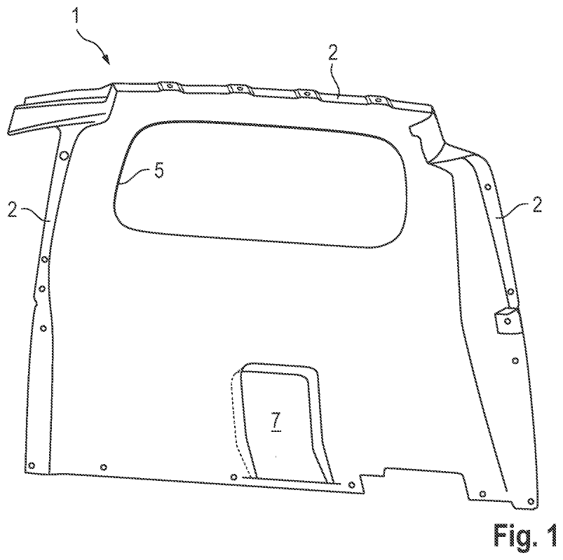

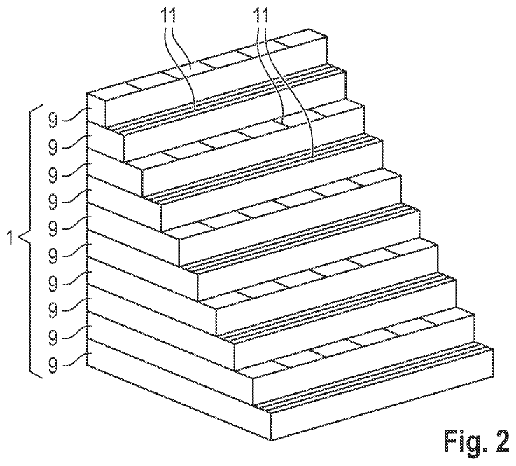

FIG. 1 shows a partition for the interior of a commercial or transport vehicle. The partition 1 has a smooth component surface without reinforcing ribs or beads. In addition, the partition 1 has a laterally circumferential joining flange 2, which can be used to connect the partition 1 inside the vehicle fixed to the body. A viewing window 5 is arranged in the upper area of the partition 1, while a through-loading function 7 is available in the lower partition area. The core of the invention is that the partition 1 is no longer made of a deep-drawn sheet steel part or an injection-molded plastic but rather is designed as a multilayer composite component made of a renewable raw material. As an example, the partition 1 can have the layer structure shown in FIG. 2. This can be formed of a total of ten wood veneer layers 9 layered on top of each other.

In order to increase the component rigidity of the partition 1, the fiber orientations 11 of the wood veneer layers 9 layered on top of each other are aligned differently with respect to each other. In this way, the component rigidity of the partition 1 can be increased without the need for additional reinforcing beads or reinforcing ribs. The ribbing and/or beading required for conventional partitions can therefore be omitted, which increases the geometric degrees of freedom in the construction of the partition 1. In addition, by eliminating the need for ribbing and/or beading, the partition 1 can be made more visually appealing.

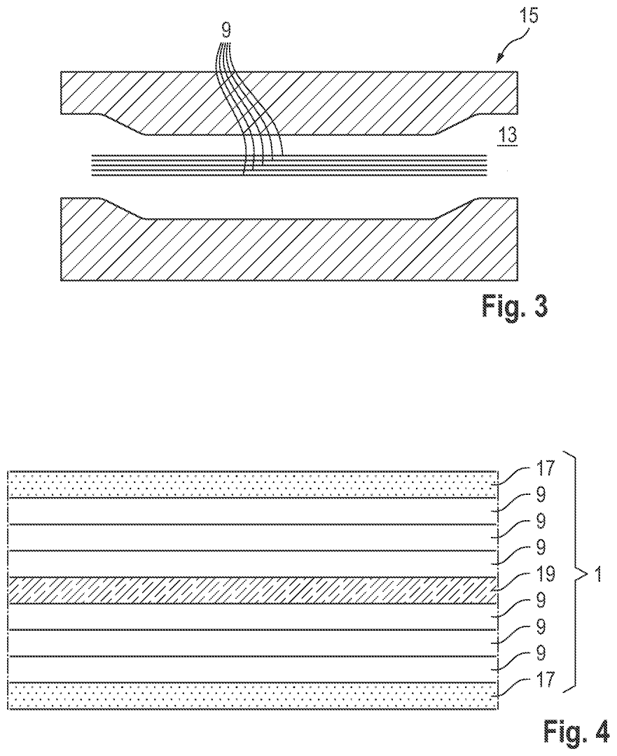

The partition 1 according to the invention is produced as follows: In a preparatory process step, the wood veneer layers 9 are coated with a binder. Subsequently, the binder-coated wood veneer layers 9 are inserted into a mold cavity 13 (FIG. 3) of a forming die 15 and pressed under pressure and heat to form the partition 1. After removal from the forming die 15, a post-treatment is carried out in which the partition 1 is brought to its final component contour, for example by machining. It may be possible to insert cutouts or clearances into the partition 1.

FIG. 4 shows the layer structure of a partition 1 according to another embodiment. As a result, the partition 1 has a top layer 17 on each of its outer sides, which is resistant to scratches/moisture/chemicals and also has a decorative function. The top layer 17 can be a layer of wood veneer impregnated with a plastic. In addition, the layer structure shown in FIG. 4 has an insulating layer 19 in the middle area, which provides a thermal and/or acoustic insulating effect. The insulating layer 19 can be an example of a fabric, non-crimp fabric, or fleece. Both the two top layers 17 and the insulating layer 19 can be inserted into the mold cavity 13 as additional insert parts together with the other wood veneer layers 9 and pressed into the multilayer composite component in the forming process.

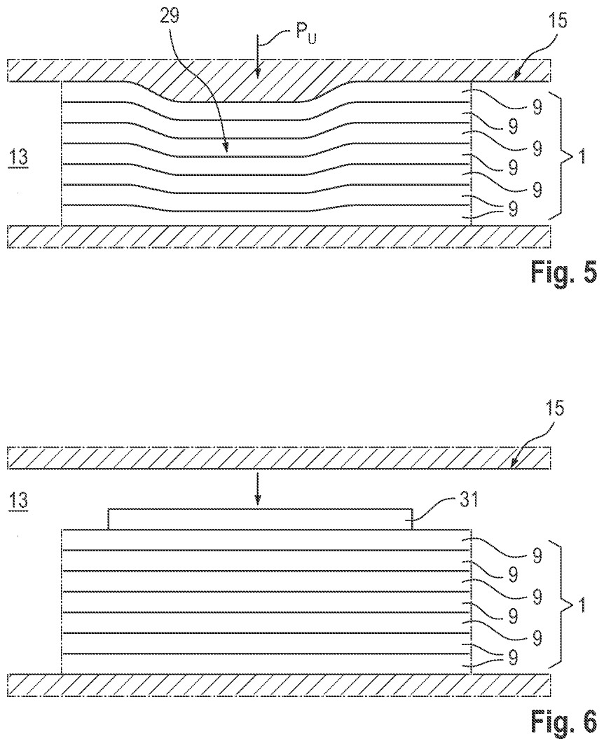

FIGS. 5 and 6 illustrate further measures to increase the component rigidity of the partition 1. Accordingly, in FIG. 5, a partition reinforcement section 29 is created by local compression. Local compression takes place in the forming process, in which the partition reinforcement section 29 is locally compressed as compared to other partition sections by an increased forming pressure p_{U}. Alternatively, in FIG. 6, the partition reinforcement section 29 is created by a local thickening. In the case of local thickening, the partition reinforcement section 29 is formed with an increased use of material as compared to other partition sections, i.e., with additional wood veneer layers 31 or alternatively, with additional chips.

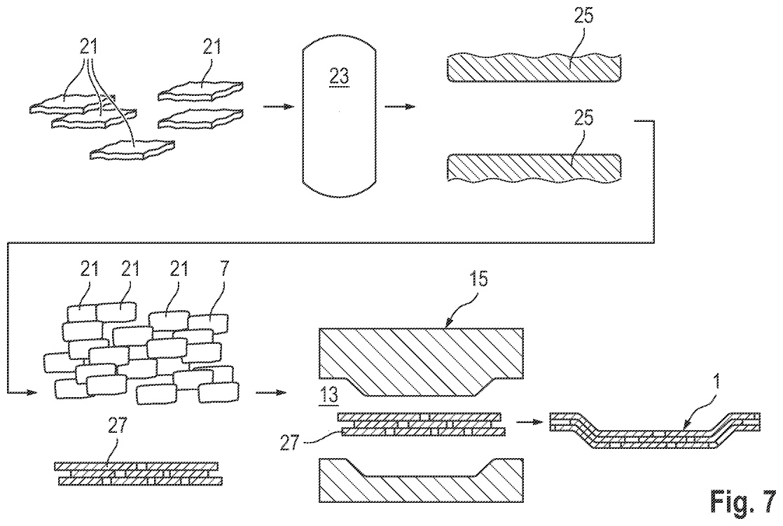

FIG. 7 shows a process sequence according to another embodiment. As a result, instead of wood veneer layers 9, wood chips 21 with a defined chip dimension are provided. The wood chips 21 are coated with a binder in a mixing station 23. The wood chips 21 pretreated in this way are then inserted into a press tool 25 and pressed into a flat semi-finished product 27. With regard to a unidirectional fiber orientation, the wood fibers of the wood chips 21 forming the flat semi-finished product 27 are unidirectionally aligned to each other in FIG. 7. The flat semi-finished product 27 produced in the press tool 25 is then inserted into the mold cavity 13 of the forming die 15. In the forming die 15, thermomechanical compression takes place under pressure, heat, and, if necessary, moisture, in which the flat semi-finished product 27 is pressed to form the partition 1.

The multilayer composite component can have structure in which wood veneer layers 9 and chips 21 are layered on top of each other in any combination. Providing these stiffening measures results in considerably greater geometrical freedom in the design of the partition 1, wherein features such as reinforcing ribs or reinforcing beads can be eliminated (ribbing, beading, functional integration, visually appealing).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the manufacture of a partition for an interior of a commercial or transport vehicle for separating a passenger compartment from a cargo compartment, the method comprising:
providing the partition as a multilayer composite component made of renewable raw materials, particularly of wood-based material;
producing the partition by a forming process in a forming die.

2. The method according to claim 1, wherein the multilayer composite component is made of wood veneer layers and/or wood chips made of renewable raw materials.

3. The method according to claim 2, wherein a preparatory process step the wood chips and/or the wood veneer layers are coated with a binder, and that in a forming process step the wood veneer layers and/or wood chips are inserted into a mold cavity of the forming die and then compressed under pressure and heat to form the partition.

4. The method according to claim 3, wherein the binder-coated chips are loosely inserted into the mold cavity as bulk material, or that the binder-coated chips are pressed into a flat semi-finished product in a pressing step before the forming process step is carried out, and that the flat semi-finished product is inserted into the mold cavity of the forming die in order to perform the forming process step.

5. The method according to claim 2, wherein for providing a partition with multidirectional fiber orientation, the fiber orientations of layered wood veneer layers are aligned differently with respect to each other, and/or that the wood chips are arranged unoriented in a random orientation in relation to each other in the multilayer composite component.

6. The method according to claim 2, wherein at least one additional insert part is inserted into the mold cavity together with the wood veneer layers and/or the wood chips for the production of the multilayer composite component, and that the additional insert part fulfills an additional function.

7. The method according to claim 6, wherein the additional insert part forms a top layer, which is resistant to scratches/moisture/chemicals and/or is decorative, and wherein the additional insert is a layer of wood veneer impregnated with a plastic, and/or wherein the additional insert has a thermal and/or acoustic insulating effect, and/or wherein the additional insert is a fabric, non-crimp fabric, or fleece.

8. The method according to claim 1, wherein for providing a partition reinforcement section a local compression is performed in which the partition reinforcement section is locally compacted in the forming process by increased forming pressure as compared to other partition sections.

9. The method according to claim 1, wherein, for providing a partition reinforcement section, a local thickening is performed in which the partition reinforcement section is formed with increased material input, or with at least one additional layer of wood veneer and/or with additional wood chips, as compared to other partition sections.

10. A partition for an interior of a commercial or transport vehicle for separating a passenger compartment from a cargo compartment, the partition comprising a multilayer composite component made of a renewable raw material, in particular of a wood-based material, which is produced by a forming process in a forming die.
